(19) United States
(12) Patent Application Publication
(10) Pub. No.: US 2002/0069288 A1
(43) Pub. Date: Jun. 6, 2002

(54) Use of unique ID's in a distributed environment to make changes to an MPEG-7 description at run time

(76) Inventors: Hawley K. Rising III, San Jose, CA (US); Ali Tabatabai, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/927,421

(22) Filed: Aug. 10, 2001

Related U.S. Application Data
(60) Provisional application No. 60/224,751, filed on Aug. 10, 2000.

(51) Int. Cl. G06F 15/16; H04N 7/16

(52) U.S. Cl. 709/231; 725/146

(57) ABSTRACT

A system and method for changing instances in a computing environment is provided. Computing devices communicate to change instances of a description structure located on one device. A second system sends a request for querying the existence of a node instance in the description structure located on the first system. The first system may then determine the appropriate node instances that fit the query and send IDs representing the appropriate node instances to the second system. Using these IDs, the second system may build a proxy address structure on its own system that mirrors the structure in the first system. Using the IDs the desired nodes may be selected and the changes for the selected nodes sent. The first system may then make the appropriate changes to the node instances using the transmitted IDs as addresses for where the changes should be made.

### CLAIM OF PRIORITY

This application claims priority from co-pending U.S. Provisional Patent Application No. 60/224,751 filed Aug. 10, 2000 entitled USE OF UNIQUE ID'S IN A DISTRIBUTED ENVIRONMENT TO MAKE CHANGES TO AN MPEG-7 DESCRIPTION AT RUN TIME which is hereby incorporated by reference, as if set forth in full in this document, for all purposes.

### BACKGROUND OF THE INVENTION

The present invention relates to the field of audio/visual content. More specifically, one embodiment of the invention provides a system and method for changing instances of a multimedia content description.

The amount of multimedia content available on the World Wide Web and in numerous other databases is growing enormously. However, the enthusiasm for developing multimedia content has led to increasing difficulties in managing, accessing, and identifying the content mostly due to their volume. To address this problem, an MPEG-7 Standard is being developed by the Moving Pictures Expert Group (MPEG), which is a working group of ISO/IEC. In contrast to preceding MPEG standards such as MPEG-1 and MPEG-2, which relate to coded representation of audio-visual content, MPEG-7 is directed to representing information relating to the description of content, and not the content itself.

The MPEG-7 standard, formally called the “Multimedia Content Description Interface” seeks to provide a rich set of standardized tools for describing multimedia content. In an MPEG-7 environment, Descriptors (D)s and Description Schemes (DS) are used to describe features, structures, and concepts related to multimedia data. More specifically, Descriptors are used to describe features and DSs used to describe structures and relations. The data or contents of Ds and/or DSs may be stored in a content description tree and may require changes and updates at run time for reasons including that progress of time has changed certain elements/attributes or that the description of media itself has changed fundamentally. Therefore, when a change needs to be made, it is desired to have a method for updating a D or DS without having to send a whole new D or DS. In other words, when a change needs to be made to a node representing an attribute or an element of a D or DS in a content description tree, a method enabling the change of just that node is desired.

One method that has been proposed is an approach that uses a numbering scheme to number the nodes of the tree structure representing the description of the multimedia content on the server. Then, deletions and additions may be made to the description structure using the numbering scheme to point to the node where the change will be taking place. The numbering scheme typically is a logical numbering of the tree structure from top to bottom. Therefore, specific nodes are identified by tracing the numbers of the nodes from the root node to the desired nodes or by specifying the number of the desired node.

The numbering scheme may work in a so-called broadcast model, where the client and server interact with only each other and the server knows the addressing scheme used on the client side. For example, the server may have created the description scheme on the client side, thus enabling the server to know the exact addressing scheme. Additionally, instead of having a single server/single client, one server may create Description Schemes on many clients. However, there are limitations with using this numbering scheme. Because the address space is assumed to be the same on both the server and the client, the system is limited to single server/single client communications. Also, a multiple client/single server system may use this numbering system; however, the clients are limited to communicating with only the single server.

In contrast, in a distributed environment such as the global internetwork of networks generally known as the Internet, many servers may interact with a client. Accordingly, multimedia data and its description may come from multiple servers. In this setting, the multimedia content description data is a description tree where each node is identified by a tag, such as a markup tag or “MediaLocator” tag that points to a media (e.g., video, audio, image) location. The description on the client side (or display device) is the description of the multimedia content that is stored locally, or being pushed on various elementary streams. Consequently, there may be no server in the environment that knows what the description tree looks like on the client side. Therefore, a numbering scheme based on a server-side description tree does not mirror the description tree on the client side because data composing the description tree has been received from various locations or different servers. Thus, each server has only partial information about the description tree on the client side.

The above problem is similar in nature to trying to use pointers in a distributed system. The components of the system do not share the same address space and therefore, pointers on one system do not have any meaning on another system because each system has its own addressing space.

### SUMMARY OF THE INVENTION

A system and method for changing instances in a computing environment is provided by virtue of the present invention. In one embodiment, computing devices communicate to change instances of a description structure located on one device. In a specific embodiment, a first system may contain a tree structure composed of fragment instances, each of which could have originated from different sources. A second system may then send a request for querying the existence of a node instance in the description structure located on the first system. The first system may then determine the appropriate node instances that fit the query and send IDs representing the appropriate node instances to the second system. Using these IDs, the second system may build a proxy address structure on its own system that mirrors the structure in the first system.

Using the IDs the desired nodes may be selected and the changes for the selected nodes sent. Also, the second system may send any number of queries back to the first system, which then sends back relevant IDs related to the queries. For example the relevant IDs may include IDs for the children of the node instance represented by the query. These IDs may then be added to the proxy address structure and the second system may now reference the proxy address structure to send the desired changes for the node instances represented by the IDs. The first system may then make the appropriate changes to the node instances using the transmitted IDs as addresses for where the changes should be made.

In one embodiment, a method for changing node instances in a content structure between a first system and a second system in a distributed computing environment is provided. In one embodiment, the method comprises receiving a request for at least one node instance in the content structure, wherein the content structure is located on the first system, sending at least one representative ID of the requested at least one node instance to the second system, selecting at least one ID in the at least one representative ID, sending the selected at least one ID in a command to change at least one node instance to the first system, and changing the at least one node instance in the content structure.

A further understanding of the major advantages of the invention herein may be realized by reference to the remaining portions of the specification in the attached drawings.

### BRIEF DESCRIPTION OF THE DRAWINGS

FIG. 1 is an illustration of a computer system suitable for use with an embodiment of the present invention;

FIG. 2 shows subsystems in the computer system of FIG. 1;

FIG. 3 illustrates a simplified block diagram of a computing environment according to one embodiment of the invention; and

FIG. 4 illustrates a method of changing instances in a computing environment according to one embodiment of the invention.

### DESCRIPTION OF THE SPECIFIC EMBODIMENTS

FIG. 1 shows a computer system 100 suitable for use to provide a system in accordance with an embodiment of the present invention. The computer system 100 includes a display 102 having a display screen 104. A cabinet 106 houses standard computer components (not shown) such as a disk drive, CD-ROM drive, display adapter, network card, random access memory (RAM), central processing unit (CPU) and other components, subsystems and devices. User input devices such as a mouse 108 having buttons 110, and a keyboard 112 are shown. Other user input devices such as a trackball, touch-screen, digitizing tablet, etc., can be used. In general, computer system 100 is illustrative of one type of computer system, such as a desktop computer, suitable for use with the present invention. Computers may be configured with many different hardware components and can be made in many dimensions and styles (e.g., laptop, palmtop, server, workstation and mainframe). Thus, any hardware platform suitable for performing the processing described herein is suitable for use with an embodiment of the present invention.

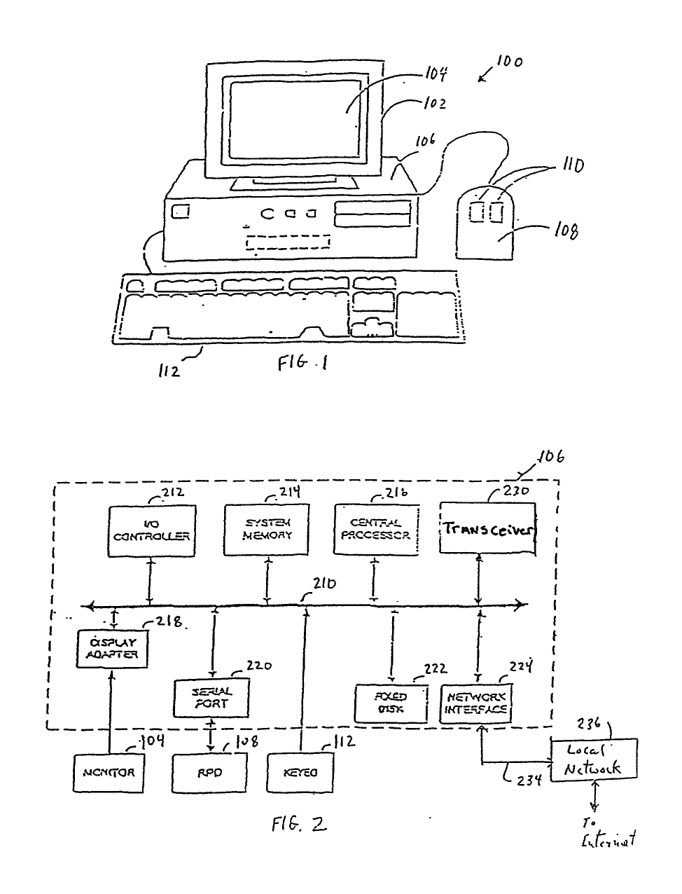

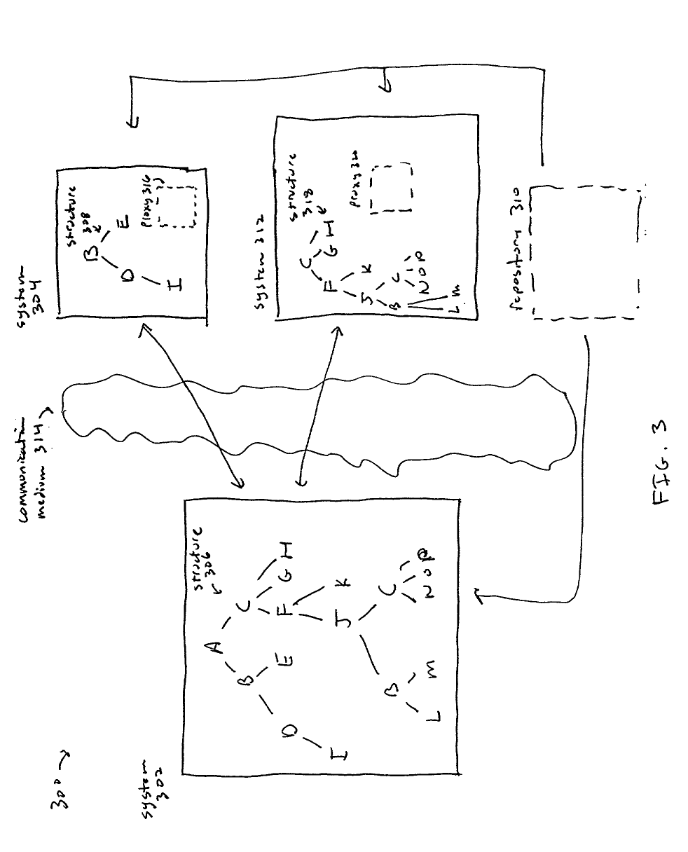

FIG. 2 illustrates subsystems found in computer system 100. Subsystems within box 106 are directly interfaced to an internal bus 210. The subsystems include input/output (I/O) controller 212, system random access memory (RAM) 214, central processing unit (CPU) 216, display adapter 218, serial port 220, fixed disk 222, network interface adapter 224 and transceiver 230. The use of the bus allows each of the subsystems to transfer data among the subsystems and, most importantly, with the CPU. External devices may communicate with the CPU or other subsystems via the bus by interfacing with a subsystem on the bus. Monitor 104 connects to the bus through the display adapter 218. A relative pointing device (RPD) such as a mouse 108 connects through the serial port. Some devices such as keyboard 112 can communicate with the CPU by direct means without using the main data bus as, for example, via an interrupt controller and associated registers (not shown). Transceiver 230 can be coupled with a satellite system, cable system, telephone lines or any other system suitable for propagating information. Transceiver 230 may include or be coupled with a communication interface, which can be coupled with bus 210.

FIG. 2 is illustrative of one suitable configuration for providing a system in accordance with an embodiment of the present invention. Subsystems, components or devices other than those shown in FIG. 2 may be added without deviating from the scope of the invention. A suitable computer system may also be achieved without using all of the subsystems shown in FIG. 2. Other subsystems such as a CD-ROM drive, graphics accelerator, etc., can be included in the configuration without affecting the performance of the system included in an embodiment of the present invention.

An embodiment of the invention is related to the use of apparatus, such as computer system 100, for using ID's in a distributed environment to make changes to an MPEG Description. According to one embodiment of the invention, use of ID's in a distributed environment to make changes to an MPEG Description is provided by computer system 100 in response to processor 216 executing one or more sequences of one or more instructions contained in system memory 214. The instructions may be read into memory 214 from a computer-readable medium, such as a fixed disk 222. Execution of the sequences of instructions contained in memory 214 causes the processor to perform the process steps described herein. One or more processors in a multi-processing arrangement may also be employed to execute the sequences of instructions contained in memory 214. In alternative embodiments, hard-wired circuitry may be used in place of or in combination with software instructions to implement the invention. Thus, embodiments of the invention are not limited to any specific combination of hardware circuitry and software.

The terms “computer-readable medium” and “computer-readable media” as used herein refer to any medium or media that participate in providing instructions to processor 214 for execution. Such media can take many forms, including, but not limited to, non-volatile media, volatile media and transmission media. Non-volatile media include, for example, optical or magnetic disks, such as fixed disk 222. Volatile media include dynamic memory, such as memory 214. Transmission media include coaxial cables, copper wire and fiber optics, including the wires that comprise bus 210. Transmission media can also take the form of acoustic or light waves, such as those generated during radio frequency (RF) and infra-red (IR) data communications. Common forms of computer-readable media include, for example, a floppy disk, a flexible disk, a hard disk, magnetic tape, any other magnetic medium, a CD-ROM disk, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer may read.

Various forms of computer-readable media may be involved in carrying one or more sequences of one or more instructions to processor 216 for execution. For example, the instructions may initially be borne on a magnetic disk of a remote computer. The remote computer can load the instructions into its dynamic memory and send the instructions over a telephone line using a modem. A modem local to computer system 100 may receive the data on the telephone line and use an infrared transmitter to convert the data to an infrared signal. An infrared detector coupled with bus 210 can receive the data carried in the infrared signal and place the data on the bus. The bus carries the data to memory 214, from which the processor retrieves and executes the instructions. The instructions received by the memory may optionally be stored on fixed disk 222 either before or after execution by the processor.

Computer system 100 also includes a network interface 224 or communication interface coupled to bus 210. The network interface or communication interface provides a two-way data communication coupling with a network link 234 that is connected to a local network 236. For example, the network interface or communication interface can be an integrated services digital network (ISDN) card or a modem to provide a data communication connection to a corresponding type of telephone line. As another example, the network interface or communication interface can be a local area network (LAN) card to provide a data communication connection to a compatible LAN. Wireless links can also be implemented. In any such implementation, network interface 224 or the communication interface and transceiver 230 send and receive electrical, electromagnetic or optical signals that carry digital data streams representing various types of information.

The network link 234 typically provides data communication through one or more networks to other data devices. For example, the network link may provide a connection through local network 236 to a host computer or to data equipment operated by an Internet Service Provider (ISP). The ISP in turn provides data communication services through the worldwide packet data communication network, now commonly referred to as the “Internet.” The local network and the Internet both use electrical, electromagnetic or optical signals that carry digital data streams. The signals that propagate through the various networks and the signals on the network link and that propagate through network interface 224, and the signals that propagate through transceiver 230, which carry the digital data to and from computer system 100, are exemplary forms of carrier waves transporting the information.

Computer system 100 may send messages and receive data, including user commands, video data, audio data and program codes through the network(s), network link 234, and network interface 224. In the Internet example, a server might transmit a requested code for an application program through the ISP, Internet, local network 236 and network interface 224. Instead of or in addition to transmission via the Internet, the computer system 100 may send and receive data via transceiver 230 and a wireless system, satellite system, cable system, telephone lines or any other system suitable for propagating information between the computer system and an information distribution system. In accordance with one embodiment, one such downloaded application provides for use of ID's in a distributed environment to make changes to an MPEG Description as described herein. Processor 216 may execute the received code as the code is received, and/or store the code on fixed disk 222, or other non-volatile storage for later execution. In this manner, the computer system can obtain an application code in the form of a carrier wave.

In one embodiment of the present invention, a computing environment may include a description of multimedia data, which may have originated from more than one source. In one embodiment, the description includes an MPEG description that may include Descriptors and Description Schemes of an MPEG or MPEG-7 standard. In one embodiment, the description is included in a structure located in a first computing system. Because nodes of the full description may have originated from different sources, such as multiple other computing systems, there may not another computing device that knows what the addressing scheme on the first computing device looks like.

In one embodiment, the computing environment described herein allows a client-server system to make changes to a structure located on the client without specific knowledge of the addressing structure used for identifying the nodes of the structure. Changes to the structure may include changing a node, adding a node, and/or deleting a node in the structure. The client may contain a description of multimedia data, which may have originated from more than one source. Because the full description was created by combining structure fragments originating from different servers, each single server has only a partial knowledge about the address structure of the nodes on the client side. Therefore, if one or more servers request changes to node instances on the client side, a communication is initiated between systems allowing an exchange of IDs representing addresses of the desired instance nodes on the client side. A proxy address structure may then be built using these IDs. The server then references the IDs to make appropriate changes to the associated node instances.

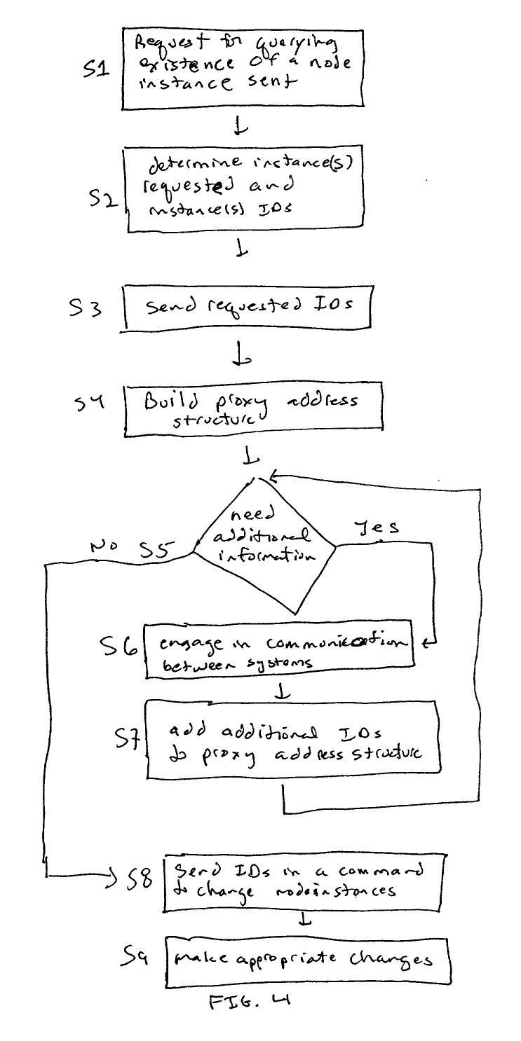

FIG. 3 illustrates a system 300 used to change instances of a structure according to one embodiment of the invention. System 300 includes system 302, system 304, and system 312. Systems 302, 304, and 312 communicate through a communication medium 314. In one embodiment, communication medium is the Internet or any other digital network, wireless network, satellite network, wire line network, or the like. Although system 300 is shown with systems 302, system 304, and system 312, it is recognized that system 300 is not limited to the shown systems and may include any number of computing devices. For example, there may be multiple clients containing content description structures and/or multiple servers wishing to make changes to the content description structures.

System 302 may be any computing device. In one embodiment, system 302 is a computing device such as computing device 100 or any personal computer, workstation, or server. System 302 will be referred to as a client in a client/server system for discussion purposes. However, it will be understood that system 302 may be a client and/or server. System 302 also includes content description structure 306. Structure 306 may be any structure capable of storing multimedia content.

In one embodiment, structure 306 is a tree structure; however, structure 306 may be organized in any logical manner and is not restricted to the shown tree structure. Structure 306 includes node instances represented by the letters A, B, C, etc. Hereinafter, node instances and nodes may be used interchangeably. As shown, node A is the root node of the structure. Node A may be referred to as a parent with children B, C, D, E, F, etc. Also, for example, node B may be referred to as the parent of children nodes D, E, and I. In a specific embodiment, each node and/or group of nodes may represent a D or DS in an MPEG or MPEG-7 Description.

System 304 may be any computing device, such as a personal computer, workstation, or server. In one embodiment, system 304 is a computing device such as computing device 100 or any personal computer, workstation, or server. System 304 will be referred to as a server in a client/server system for discussion purposes. However, it will be understood that system 304 may be a client and/or server. System 304 also includes content description structure 308. Structure 308 may be any structure capable of storing multimedia content. As shown, structure 308 includes the tree structure of a parent B, with children nodes D, E, and I. System 304 also includes a proxy structure 316, hereinafter described.

System 312 may be any computing device, such as a personal computer, workstation, or server. In one embodiment, system 312 is a computing device such as computing device 100 or any personal computer, workstation, or server. System 312 will be referred to as a server in a client/server system for discussion purposes. However, it will be understood that system 312 may be a client and/or server. System 312 also includes content description structure 318. Structure 318 may be any structure capable of storing multimedia content. As shown, structure 318 includes the tree structure of a parent C, with children nodes F, G, H, J, K, B, C, L, M, N, O, and P. System 312 also includes a proxy structure 320, hereinafter described.

As mentioned above, multimedia content description data may come from multiple locations in a distributed environment. Therefore, in one embodiment, node B with the children D, E, and I may have originated from system 304 and node C with children F, G, H, etc. may have originated from system 312. Thus, it is possible that no system may know the exact addressing scheme of the structure of full description instance on system 302. Accordingly, in one embodiment, IDs may be assigned to all nodes or certain nodes in order to facilitate communication between systems. In a specific embodiment, the ID may be either a unique ID or a universal ID (“UID”). Unique and universal IDs are known in the art and may be generated using any methods known in the art, such as with SMPTE (Society of Motion Picture and Television Engineers) UIDs.

In one embodiment, system 304 may not know the exact structure of content description structure 306 on system 302. However, system 304 may have parts of system 302's content description structure 306 on its own system. For example, system 304 may have created, stored, or put structure 308 (node B with children D, E, and I) on system 302. However, even if system 304 put the nodes on system 302, system 304 may not know the exact addressing scheme to locate and make changes to structure 306 in system 302 because different parts of the structure may have come from multiple locations. For example, node A and node C with its children nodes may have originated from different sources. Also, system 304 may know there is a node B with children D, E, and I on system 302 but does not know the nodes' exact addresses or how to reference the nodes. In another case, system 304 may not know or have put any of the tree fragments (nodes) in structure 306 and thus, may not be able to reference any of the nodes in structure 306.

In a specific embodiment, a repository 310 may be included in system 300 and may be any storage device capable of being accessed by systems 302, 304, and 312. Repository 310 may contain IDs for all or some of the node instances of structure 306 on the client 302. Preferably, node instances and their corresponding IDs that are deemed important or accessed frequently will be stored in repository 310. Any system may then query repository 310 for an ID of a certain node instance and then use the ID when communicating with a client. Additionally, repository 310 may include an entry specifying the client or clients where an instance is located. Therefore, a server would know what clients contain the instance and may communicate with only those clients.

FIG. 4 illustrates a method of changing node instances in content description structure 306 according to one embodiment. In step S1, a request for querying the existence of a node instance in structure 306 is sent to system 302 when system 304 decides to make a change to structure 306. In a specific embodiment, an instance of an MPEG description, such as a Descriptor or description scheme in MPEG-7 may be requested. Although the method will be described with reference to system 304 and 302, it will be understood that the method is not limited to just system 302 and system 304 and may include any combination of systems 302, 304, 312, and any other system known in the art.

In step S2, system 302 determines the instance(s) requested and the instance and/or instances' IDs. The IDs may be pre-generated prior to the request or may be generated when the request is received. Additionally, IDs may be pre-generated for certain nodes and other IDs generated for remaining nodes when a request is received. Further, in a specific embodiment, repository 310 may be queried for the desired node instance(s) IDs by system 304. Once the desired IDs are exchanged, system 304 uses the IDs from repository 310 to communicate with system 302 as if system 302 had returned the IDs to system 304.

In one embodiment, the request from system 304 may include multiple node instances or a group of node instances. For example, instance C may be requested and/or all the children nodes connected to node C may be requested. Also, if there are multiple instantiations of the same node instance, IDs for every node instance may be returned. For example, if instance B is requested from structure 306, two IDs may be returned because there are two instances of node B in the structure. After receiving a request, system 302 traverses the structure and returns the IDs for all the requested node instances.

In step S3, the requested IDs are sent to system 304.

In step S4, a proxy address structure may be built on system 304 with the received IDs. The proxy structure mirrors the address structure on system 302. The proxy structure uses the IDs to reference the node instances. For example, if node C and children nodes F, G, H, etc. were requested, a proxy address structure using the IDs is built with node C as the root node with children nodes F, G, and H. Therefore, parts of structure 306 on system 302 may be built without having knowledge of the whole structure 306. Additionally, system 304 may assume or know the node structure related to the node represented by the ID. For example, system 304 may have put node B with associated children D and E onto system 302. Thus, a proxy address structure with the ID for node B and children nodes D and E may also be built without communicating with system 302. It will be understood that other proxy address structures may be used by system 304 to reference and communicate IDs with system 302. In another embodiment, system 304 may request IDs for node instance B and/or the children nodes D, E, and I. Although system 304 includes structure 308 with nodes B, D, E, and I, system 304 may not know the exact addressing structure of the nodes on system 302. For example, even though system 304 may have put nodes B, D, E, and I on system 302, the addressing structure on system 302 may be different because node A is the parent node with children nodes B, D, E, and I. Thus, system 302 may have a different addressing structure than system 304's addressing structure.

In step S5, system 304 determines whether the proxy structure includes enough information to make the desired changes. System 304 determines if the proxy address structure includes all the IDs of desired node instances. If so, the process continues at step S8 where system 304 references the proxy address structure to make changes to structure 306 in system 302.

If system 304 does not have all the desired IDs after making the initial request, system 304 may enter into a communication with system 302 (step S6). In this step, a request that further information be sent back to system 304 using an ID in the proxy address structure may be made. A communication may include as many requests as necessary to gather the appropriate data to build a proxy address structure. For example, system 304 may use the ID to request the children of the ID representing a node be sent back. Thus, IDs for the children of the node are sent to system 304.

In step S7, the requested IDs are added to system 304's proxy address structure. System 304 then determines again if the proxy address structure includes all IDs of the desired instances (step S4). This process continues until system 304 has built the appropriate proxy address structure needed to make the desired changes to structure 306.

In step S8, IDs are used in a command to send changes to system 302 once the desired proxy address structure is completed. For example, system 304 may send a command to change or delete a node represented by an ID. Additionally, a command to add nodes with reference to a node represented by an ID may be sent. Further, a command may be sent that references nodes related to an ID. For example, system 304 may send a command with the ID for node C stating that children nodes F, G, or H should be changed. Additionally, system 30 may specify that a node down one level or over one level should be changed in reference to the ID. Basically, system 304 uses the ID represented by node C and specifies changes related to that ID.

In step S9, system 302 makes the appropriate changes in content description structure 306. In a specific embodiment, the changes are made to elements/attributes of an MPEG description such as Descriptors and Description schemes of an MPEG or MPEG-7 standard.

The above description is illustrated but not restrictive. Many variations of the invention will become apparent to those skilled in the art upon review of this disclosure. The scope of the invention should, therefore, be determined not with reference to the above description, but instead should be determined with reference to the pending claims along with their full scope or equivalents.

What is claimed is:

1. A method for changing node instances in a content structure between a first system and a second system in a distributed computing environment, the method comprising:
receiving a request for at least one node instance in the content structure, wherein the content structure is located on the first system;
sending at least one representative ID of the requested at least one node instance to the second system;
selecting at least one ID in the at least one representative ID;
sending the selected at least one ID in a command to change at least one node instance to the first system; and
changing the at least one node instance in the content structure.

2. The method of claim 1, wherein content description comprises an MPEG description.

3. The method of claim 1, wherein the ID is a universal ID.

4. The method of claim 1, wherein the content structure is a tree structure.

5. The method of claim 1, wherein the step of sending at least one ID comprises sending IDs for the requested at least one node instance and IDs for node instances related to the requested at least one node instance.

6. The method of claim 1, further comprising the steps of:
selecting, at the second system, at least one ID and sending a request for at least one node instance associated with the selected at least one ID to the first system; and
sending at least one ID associated with the selected at least one ID to the second system.

7. The method of claim 1, further comprising the step of creating a proxy structure on the second system using the at least one ID.

8. The method of claim 1, wherein changing the at least one node instance in the content structure comprises deleting the at least one node instance.

9. The method of claim 1, wherein changing the at least one node instance in the content structure comprises editing the at least one node instance.

10. The method of claim 1, wherein changing the at least one node instance in the content structure comprises adding a node instance in relation to the at least one node instance.

11. A system for changing node instances in distributed computing environment comprising:
a content structure comprising at least one node instance;
a first system comprising logic to receive a request for at least one node instance in the content structure and send at least one ID representative of the requested at least one node instance; and
a second system comprising logic to select at least one ID and send a command to change the node selected at least one ID,
wherein the first system comprises logic to change the corresponding at least one node instance in the content structure using the selected at least one ID.

12. The system of claim 11, wherein the content structure comprises an MPEG description.

13. The system of claim 11, wherein the ID is a universal ID.

14. The system of claim 11, wherein at least one ID representative of the requested at least one node instance comprises at least one node instance and children of that node instance.

15. The system of claim 11, wherein the second system comprises logic to select at least one ID and send the selected at least one ID to the first system,
wherein the first system comprises logic to send at least one ID associated with the selected ID to the second server.

16. The system of claim 15, wherein the second system comprises logic to create a proxy structure using the at least one ID.

17. A method for changing node instances of an MPEG description in a content description structure between a first system and a second system in a distributed computing environment, the method comprising:
receiving a request for at least one node instance of the MPEG description in the content description structure, wherein the content description structure is located on the first system;
sending at least one representative ID of the requested at least one node instance to the second system;
selecting at least one ID in the at least one representative ID;
sending the selected at least one ID in a command to change at least one node instance to the first system; and
changing the at least one node instance in the MPEG description in the content description structure.

18. The method of claim 15, wherein the MPEG description comprises a Descriptor.

19. The method of claim 15, wherein the MPEG description comprises a Description Scheme.

20. A data signal embodied in a carrier wave including instructions for changing node instances in a content structure between a first system and a second system in a distributed computing environment, the method comprising:
one or more instructions for receiving a request for at least one node instance in the content structure, wherein the content structure is located on the first system;
one or more instructions for sending at least one representative ID of the requested at least one node instance to the second system;
one or more instructions for selecting at least one ID in the at least one representative ID;
one or more instructions for sending the selected at least one ID in a command to change at least one node instance to the first system; and
one or more instructions for changing the at least one node instance in the content structure.

21. A computer-readable medium including instructions for changing node instances in a content structure between a first system and a second system in a distributed computing environment, the computer-readable media comprising:
one or more instructions for receiving a request for at least one node instance in the content structure, wherein the content structure is located on the first system;
one or more instructions for sending at least one representative ID of the requested at least one node instance to the second system;
one or more instructions for selecting at least one ID in the at least one representative ID;
one or more instructions for sending the selected at least one ID in a command to change at least one node instance to the first system; and
one or more instructions for changing the at least one node instance in the content structure.
